(19) United States
(12) Patent Application Publication
(10) Pub. No.: US 2009/0025572 A1
(43) Pub. Date: Jan. 29, 2009

(54) Apparatus for Holding Food Items for Roasting in a Fire

(76) Inventor: Mark E. Riesterer, Valders, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/782,019

(22) Filed: Jul. 24, 2007

(51) Int. Cl. A47J 37/04

(52) U.S. Cl. 99/421 A

(57) ABSTRACT

An appliance for holding food items, such as marshmallows and hot dogs, for roasting against the face of an open fire includes food carrying skewers that are rotatably mounted on an axis generally perpendicular to the elongated frame of the device. A drive linkage, manually operated from the opposite end of the frame, rotates the skewers such that the food products are uniformly exposed to the same heating, resulting in uniformly cooked food items without burning.

### BACKGROUND OF THE INVENTION

The present invention relates to an apparatus for holding food items, such as marshmallows and hot dogs, for roasting before an open fire. More particularly, the apparatus permits the user to turn the food items, mounted on a skewer, on an axis generally perpendicular to the skewer mounting frame and parallel to the face of the fire.

Many devices have been developed to hold food items for roasting against the face of or over a camp fire or other open fire. Such devices typically have a fairly long frame, which may comprise a simple rod, with a handle at one end and a skewer or other holding device at the other end. The frame is long enough to permit the user to hold one end and place the food item close to the fire without causing heat discomfort (or worse) to the user. The skewer or other food-holding device typically extends axially from the end of the frame. The prior art also teaches means for rotatably mounting the skewer on its axis.

A problem typical to all known prior art devices is that the free end of the food item mounted on the skewer is always closest to the face of the fire and, even if the skewer is turned on its axis, the free end of the food item is typically overcooked or burned, the opposite end nearest the user is undercooked or uncooked, and, overall, the food item is not uniformly roasted. As an example and in a more rudimentary form, a marshmallow impaled on the end of a long stick will catch fire on its free end or face, even if the stick is rotated, and often catch fire and burn without the end nearest the user being toasted or cooked at all.

### SUMMARY OF THE INVENTION

In accordance with the present invention, an apparatus for holding food items for roasting against the face of an open fire includes an elongate frame that has a handle at one end and a skewer at the opposite end. The skewer is mounted for rotation on an axis that is generally perpendicular to the frame and parallel to the face of the fire. A rotatable drive is mounted on the handle end of the frame, and the frame carries a linkage that operatively connects the skewer and the drive such that manual rotation of the drive by the user rotates the skewer. The result is the ability to uniformly roast the food item without reorienting the device to reposition the food item.

In one embodiment, the drive linkage comprises a skewer crank that is connected to the skewer for rotation on the skewer axis. A drive crank is connected to the drive end of the frame for rotation on an axis parallel to the axis of rotation of the skewer, and a connecting rod is rotatably attached at opposite ends to the skewer crank and the drive crank.

In one preferred embodiment, there is a pair of oppositely extending coaxial skewers. A skewer crank is connected to each skewer and each skewer crank has a crank arm connected at one end and extending perpendicular to the skewer with the crank arms rotatably displaced from each other around the skewer axis. A common arm interconnects the ends of the skewer crank arms. The drive crank has a pair of drive crank arms that are rotatably connected at one end to the frame on a crank axis that is parallel to the skewer axis. The drive crank arms extend perpendicular to the crank axis and are rotationally displaced from each other on the crank axis and positioned parallel to one of the skewer crank arms. A common drive-end arm interconnects the other ends of the crank arms. A manually engageable crank is operative connected to one of the drive crank arms on the crank axis.

### BRIEF DESCRIPTION OF THE DRAWINGS

FIG. 1 is a perspective view of the apparatus of the present invention.

FIG. 2 is an enlarged top plan view of the apparatus shown in FIG. 1.

FIG. 3 is an enlarged side elevation of the apparatus shown in FIG. 1.

### DETAILED DESCRIPTION OF THE INVENTION

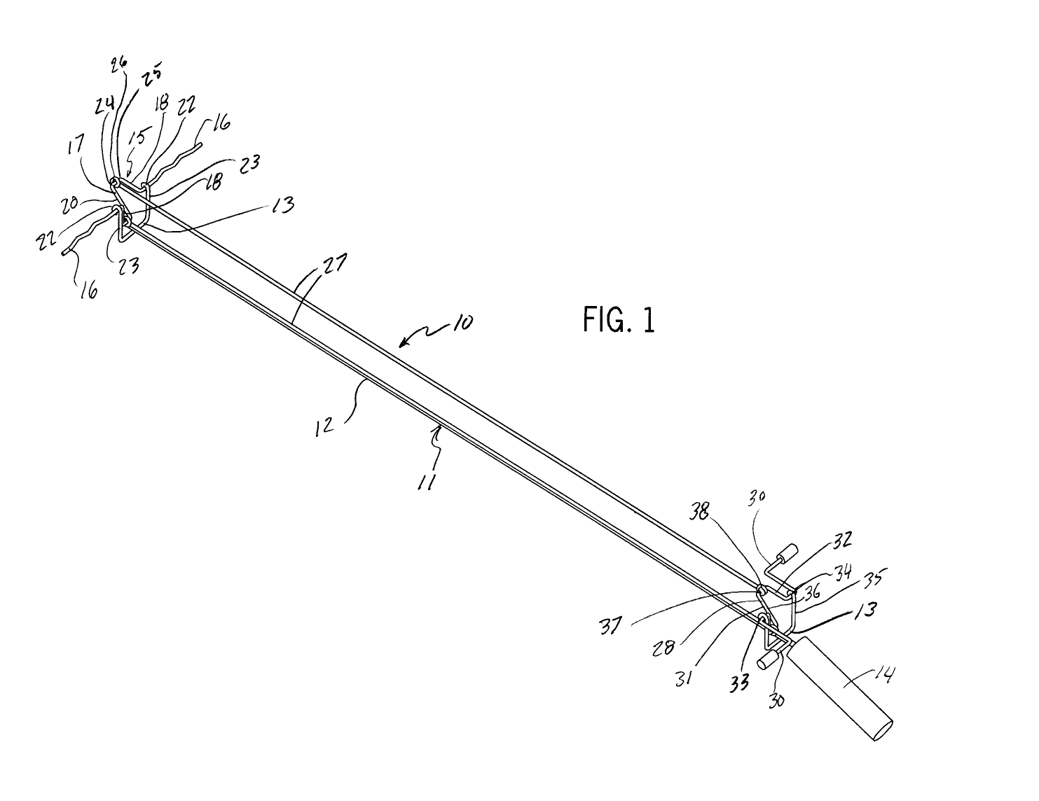

Referring first to FIG. 1, a roaster 10 for marshmallows, hot dogs and the like, is shown in a presently preferred embodiment. The roaster may be conveniently made almost entirely of wire or small diameter rod stock, preferably steel. The steel may be plated and, if so, nickel plating is presently preferred. The roaster 10 includes an elongate frame 11 including a main frame member 12 and U-shaped supports 13. One support 13 is attached to the end of the main frame member 12 and the other U-shaped support is attached near but spaced from the opposite end of the main frame member 12. The free end of the main frame member 12 is bent slightly and a user handle 14 is attached to the bent end. The handle 14 may be made of any suitable material that provides a suitable grip. In the embodiment shown, the frame 11 may be about 3-½ ft. long, but smaller or larger versions may also be suitably adapted for the intended use.

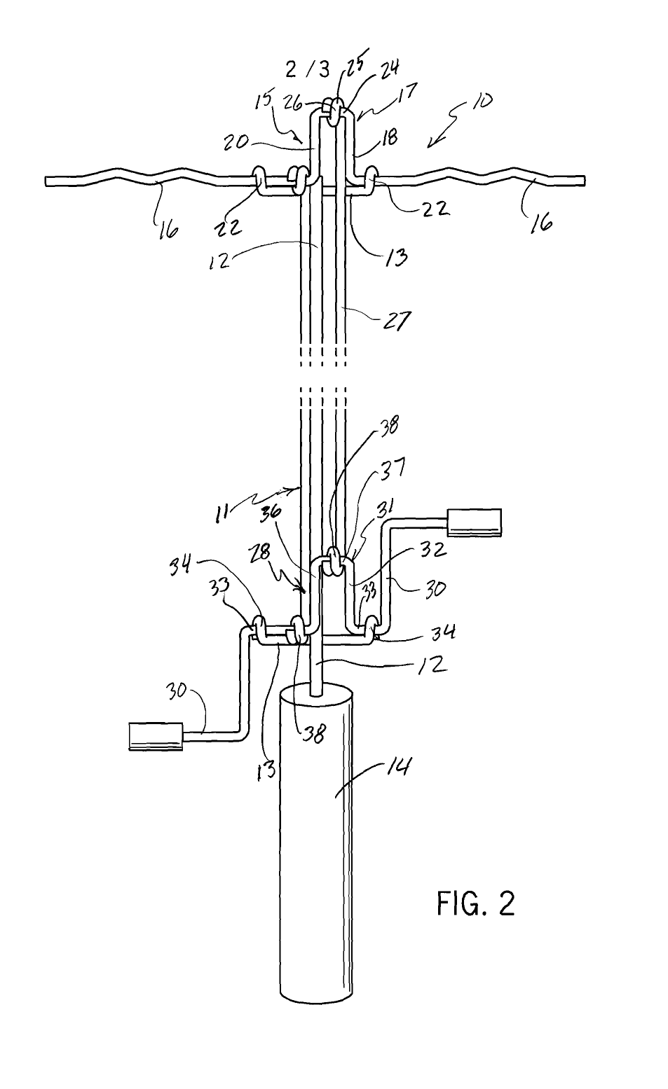

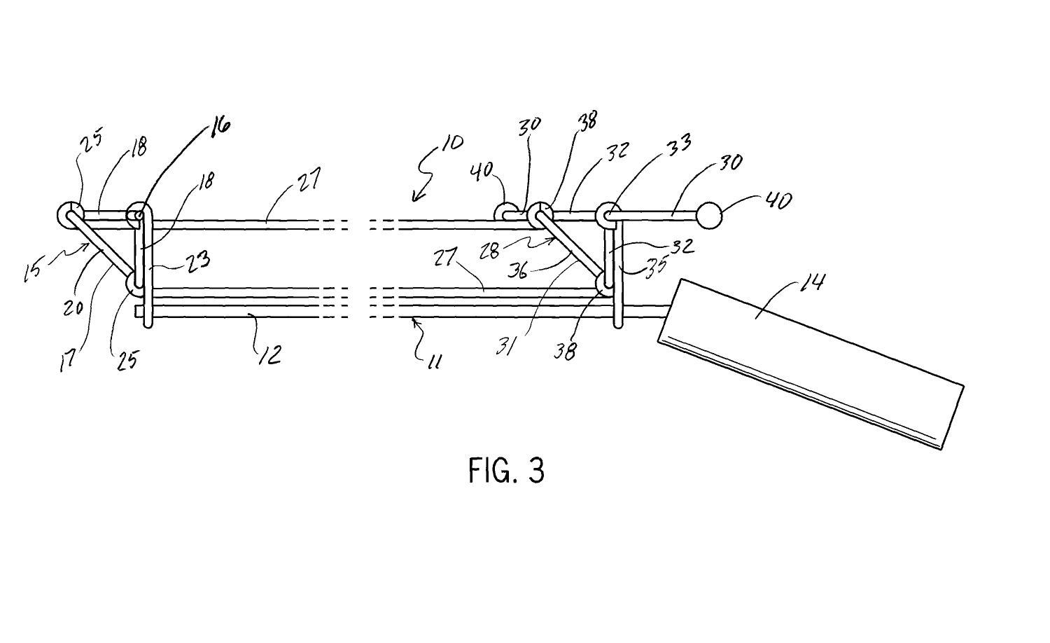

Referring also to FIGS. 2 and 3, the U-shaped support 13 at the distal end of the roaster 10 carries a rotatable crank and skewer body 15. The crank and skewer body includes a pair of oppositely extending coaxial skewers 16 that are interconnected by a double-armed crank 17. One end of each crank arm 18 is attached to a skewer 16 and the opposite ends of the crank arms 18 are interconnected by a common arm 20. Each crank arm 18, at its connection to a skewer 16, is rotationally carried in a wrapped wire swivel joint 22 formed at the end of one of the legs 23 of the U-shaped support 13. The skewers 16 are thereby held for rotation on their common axis which is generally perpendicular to the frame 11. The opposite end of each crank arm 18 is integrally connected to the common arm 20 by a short crank axle 24 to each of which is rotatably attached a swivel joint 25 formed by a bent wire end 26 of a connecting rod 27 of an operating drive linkage which will be described in detail hereinafter.

At the opposite end of the frame 11, a manually rotatable cranking body 28 is rotatably attached to the ends of the U-shaped support 13. The cranking body 28 includes a pair of hand cranks 30 interconnected for rotation on a common axis by a double-armed crank 31 that is identical in size and shape to the double armed crank 17 on the skewer end of the frame 11. Thus, the double-armed crank 31 includes a pair of crank arms 32 one end of each of which is connected to one of the hand cranks 30 by a short stub axle 33. The stub axles 33 lie on a common axis and are rotatably supported by swivel joints 34 formed in the ends of the legs 35 of the U-shaped support 13. The opposite ends of the crank arms 32 are connected by a common arm 36 with short crank axles 37 at opposite ends of the common arm. Each crank axle 37 is rotatably connected to a proximal end of a connecting rod 27 via a wrapped wire swivel joint 38.

When viewed from the side, as shown in FIG. 3, each crank arm 18 or 32 is displaced rotationally from the end of the interconnecting common arm 20 or 36 by an acute angle of about 45°. Also, the swivel connections 25 (or 34) of the connecting rods 27 to the common arm 20 (or 36) are displaced rotationally with respect to the skewer axis (or the crank axis) by about 90°. The connecting rods 27 are of equal length and, at any point in the arc of rotation of the hand cranks 30, the cranking body 28 on the drive end of the linkage and the crank and skewer body 15 on the skewer end of the linkage are identically positioned rotationally. The radial offset of the crank axle swivel joints 38 from the common axes of the crank stub axles 33, along with the identical radial offset of the crank axle swivel joints 25 on the skewer end of the frame, provides a moment arm for transferring the rotational force from the hand cranks 30 to the ends of the connecting rods 27. The identical shape and orientation of crank and skewer body 15 and the cranking body 28 cause the connecting rods to reciprocate and translate the rotational movement of the crank directly into rotational movement of the skewer 16. Angular offset of the crank arms 18 and 32 assures positive transfer of driving force from the drive end double-armed crank 31 to the skewer end double-armed crank 17 at all rotational positions thereof. As mentioned above, with the roaster 10 held generally perpendicular to the face of an open fire, the skewers 16 rotate the food items such that the outside surfaces of the food are uniformly heated both axially and circumferentially.

In the embodiment shown in the drawings, main frame member 12 extends along the underside of the frame 11, permitting the user to rest the roaster 10 on an object that surrounds the open fire, such as a rock, fire ring or log. This helps support the weight of the roaster and the food item being cooked thereon. However, the roaster 10 may be inverted, with the main frame member 12 on top, and operated in an identical manner, but without the ability to provide the supplemental support.

There are two hand cranks 30 in the embodiment shown. This facilitates use by either right-handed or left-handed users, but a single crank 30 would be adequate. If a crank 30 is eliminated, the associated stub axle 33 would have to be suitably capped to prevent it from being dislodged axially from its associated swivel joint 34.

As shown in the drawings, the oppositely extending coaxial skewers have a staggered or rippled shape to help prevent the attached food product from falling off or becoming inadvertently dislodged. However, many shapes of skewers may be utilized including two-pronged forks of shorter or longer length.

Other constructions of the swivel joints 22, 25, 34 and 38 are possible. For example, the ends of the connecting rods 27 and the ends of the U-shaped supports 13 could be swaged or coined flat and bent to form cylindrical bushings with greater bearing surfaces. Alternately, split bushings could be welded to the ends of the connecting rods and U-shaped supports and closed around the associated stub axles 21 and 33 and crank axles 24 and 37.

Although wire or rod stock is presently believed to be best suited for ease of manufacture, cost and operation of the roaster 10, steel or other metals having suitable heat resistance in other cross sectional shapes could be used as well. In the embodiment shown, all of the members are made of the same gauge wire, except the main frame member 12 which is made of a heavier gauge material.

Steel wire, plated after assembly, is the preferred material for making the subject roaster. However, stainless steel is also suitable, as would be other metals of suitable heat resistance and strength.

The ends of the hand cranks 30 are preferably provided with rotatable sleeves 40 to facilitate cranking. The sleeves 40, like the handle 14, may be made of any suitable material, including wood, plastic, rubber or metal.

A significant aspect of the present invention is the orientation of the skewers 16 generally perpendicular to the longitudinal axis of the frame 1 1. Food items, such as hot dogs and marshmallows, attached to the skewers rotate uniformly against and generally equally spaced from the face of an open fire. The result is uniform roasting, through cooking of the food product and little likelihood that the product will be burned. Rotary motion could be imparted to the skewers 16 with the use of other drive arrangements than the crank and connecting rod drive disclosed above. For example, the drive could comprise bevel gear arrangements on opposite ends of a rotary driveshaft. A chain and sprocket drive could also be used, but such an arrangement would require a more robust and rigid frame, all adding to the cost of manufacturer. Also, although for simplicity and low cost, a manual drive arrangement is most desirable, the drive could be powered by a small electric motor.

I claim:

1. An apparatus for holding and turning food items for roasting in a fire comprising:
an elongate frame having a handle at one end and a skewer at the opposite end;
the skewer mounted on said opposite end for rotation on an axis generally perpendicular to the frame;
a rotatable drive mounted on said one end of the frame; and,
a drive linkage carried on the frame and operatively connecting the skewer and the drive for rotation of the skewer.

2. The apparatus as set forth in claim 1 wherein the drive linkage comprises:
a skewer crank connected to the skewer for rotation on the skewer axis;
a drive crank connected to said one end of the frame for rotation on a crank axis parallel to the axis of rotation of the skewer; and,
a connecting rod rotatably attached at opposite ends of the skewer crank and the drive crank.

3. The apparatus as set forth in claim 2 comprising:
a pair of oppositely extending coaxial skewers;
a skewer crank connected to each skewer, each skewer crank having a crank arm connected at one end and extending perpendicular to the skewer with said crank arms rotationally displaced from each other around the skewer axis;
a common arm interconnecting the other ends of the skewer crank arms;
said drive crank having a pair of drive crank arms rotatably connected at one end to the frame on a crank axis parallel to the skewer axis, the drive crank arms extending perpendicular to the crank axis;
said drive crank arms rotationally displaced from each other on said crank axis and positioned parallel to one of the skewer crank arms;
a common drive-end arm interconnecting the other ends of the drive crank arms; and,
a manually engageable crank operatively connected to one of the drive crank arms on the crank axis.
